(19) United States
(12) Patent Application Publication
(10) Pub. No.: US 2024/0217353 A1
(43) Pub. Date: Jul. 4, 2024

(54) DATA LOGGING AND TRANSMISSION DEVICE FOR AN ELECTRIC AIRCRAFT

(71) Applicant: ROLLS-ROYCE plc, London (GB)

(72) Inventors: Sivakumar NADARAJAN, Singapore (SG); Shanjiao JIANG, Singapore (SG); Thiha KYAW, Singapore (SG); Amit GUPTA, Singapore (SG)

(73) Assignee: ROLLS-ROYCE plc, London (GB)

(21) Appl. No.: 18/536,570

(22) Filed: Dec. 12, 2023

(30) Foreign Application Priority Data
Jan. 4, 2023 (GB) 2300049.0

(51) Int. Cl. B60L 53/14; H02J 7/00; H02J 13/00

(52) U.S. Cl. CPC B60L 53/14; H02J 7/00032; H02J 7/0047; H02J 13/00022; B60L 2200/10

(57) ABSTRACT

A data logging and transmission device is provided for an electric aircraft having a charging port for on-ground charging of an energy storage system of an electric propulsion system of the aircraft. The device includes: a control unit, data storage unit, data transmitter, and sensor configured to detect connection of charging port of the electric aircraft to ground-side charger and then issue a trigger signal to the control unit. The control unit is configured wherein a state of flight of the electric aircraft, the control unit collects inflight data from the electric aircraft and saves the inflight data to the data storage unit. The control unit is also configured such that in a state of on-ground charging of the electric aircraft, the control unit, on receipt of the trigger signal, commands the data transmitter to transmit the inflight data saved on the data storage unit to a remote receiver.

### CROSS-REFERENCE TO RELATED APPLICATIONS

This specification is based upon and claims the benefit of priority from United Kingdom Patent Application No. 2300049.0, filed 4 Jan. 2023, the entire contents of which are incorporated herein by reference.

### FIELD OF THE INVENTION

The present invention relates to a data logging and transmission device for an electric aircraft.

### BACKGROUND

Interest in aircraft with purely electric and hybrid electric propulsion systems is increasing because of the need to reduce carbon emissions and pollution, and because of developments in the facilitating electrical technologies. Hybrid electric propulsion systems include both internal combustion engines, for example gas turbines or diesel engines, and energy storage, typically in the form of batteries. Purely electric propulsion systems completely dispense with internal combustion engines and use only batteries and/or, in some instances, fuel cells, as an energy source for their propulsors.

Urban Air Mobility (UAM) refers to the use of aircraft—typically purely electric aircraft—to transport passengers relatively short distances, for example tens of kilometres. Most proposed UAM platforms, sometimes known as ‘air taxis’ or ‘flying taxis’, have Vertical Take-Off and Landing (VTOL) or Short Take-Off and Landing (STOL) capabilities so that the aircraft can take-off and land at locations convenient for passengers. Hybrid electric aircraft may have greater ranges.

FIG. 1 illustrates an electric aircraft 10 which may be used for UAM applications. The aircraft includes a fuselage 11, which incorporates a cabin for occupants, and a distributed propulsion system which in this case has six open rotor propulsors 12 driven by rotary electric machines. Also visible in FIG. 1 is a retractable undercarriage 15 in which a landing platform, in this case having wheels, can be stowed during flight.

The size of the fuselage 11 and the cabin will depend on the application requirements, but in this example they are sized for five occupants including a pilot. It is however envisaged that some UAM platforms will not require a pilot and will instead be flown under the control of an autopilot system.

Four of the propulsors 12 are attached to the wings 13 of the aircraft 10, and the remaining two propulsors 12 are attached to a separate flight control surface 14 located towards the rear of the aircraft 10. In this embodiment the wings 13 and the rear control surface 14 are tiltable between a VTOL configuration in which the axes of the rotors point upward and a horizontal flight configuration in which the axes of the rotors point forward. The horizontal flight configuration, whilst principally used for horizontal flight, may also be used for taxiing and possibly STOL operation if supported.

The electrical systems, including the electric machines that power the aircraft 10, receive electrical power from one or more battery packs located within the aircraft. The battery packs may be located in any suitable part or parts of the aircraft, including the fuselage 11, the wings 13 and the propulsors 12.

Whilst the illustrated aircraft 10 is an electric VTOL (eVTOL) aircraft, it will be appreciated that UAM platforms could also be of the STOL type. Hybrid electric platforms may utilize similar distributed propulsion system configurations, but the underlying power system may be a series hybrid, parallel hybrid, turboelectric or other type of hybrid power system.

It would be desirable to perform regular health assessments to identify faults and possible maintenance needs of such aircraft systems. The present invention has been devised in light of this consideration.

### SUMMARY

In a first aspect, the present disclosure provides a data logging and transmission device for an electric aircraft having a charging port for on-ground charging of an energy storage system of an electric propulsion system of the aircraft, the device comprising: a control unit, a data storage unit, a data transmitter, and a sensor configured to detect connection of the charging port to a ground-side charger and then issue a trigger signal to the control unit, wherein the control unit is configured such that: in a state of flight of the electric aircraft, the control unit collects inflight data from the electric aircraft and saves the inflight data to the data storage unit, and in a state of on-ground charging of the electric aircraft, the control unit, on receipt of the trigger signal, commands the data transmitter to transmit the inflight data saved on the data storage unit to a remote receiver.

The data logging and transmission device of the first aspect has an advantage that inflight data is transmitted only while the aircraft is in a state of charging. The charging state of the aircraft is a reliable indicator that the aircraft is grounded and effectively dormant, and that it is therefore safe for the data logging and transmission device to transmit data. Aircraft systems other than the data logging and transmission device are typically either powered off or in a sleep mode while the aircraft is charging, meaning that the possibility of electrical interference between the transmission signal and the on-board electronics is reduced. Moreover, while the aircraft is charging, other aircraft systems do not need to transfer inflight data to the data logging and transmission device. Therefore, the device is not required to receive and log data during charging and may solely transmit saved data.

Furthermore, the data logging and transmission device may advantageously provide a self-contained system. Conventional DLTUs require input from external sensors, such as a WoW sensor, to determine the flight status of the aircraft. This greatly limits the range of electric aircraft that a WoW-configured DLTU may be used in. By contrast, the data logging and transmission device (or wider propulsion system containing the data logging and transmission device) may reasonably be outfitted to any electric aircraft or electric aircraft airframe.

Moreover, the sensor of the data logging and transmission device can simplify the control unit logic of the device. The control unit may simply initiate data transfer on receipt of the trigger signal without having to account for possible on-ground operational states or variations that are present in alternative signals such as the WoW sensor signal. Additionally, as electric aircraft are charged while stationary, the data logging and transmission device can be prevented from transmitting data while in non-dormant, on-ground operational states (such as taxiing or during take-off preparation). Therefore, the data logging and transmission device does not have to make any complex decisions regarding the safety of data transmission. These simplifications result in a less complex data logging and transmission device and therefore lower certification requirements, and a lower cost.

The control unit may also be configured such that the trigger signal may be used in conjunction with other aircraft signals (such as a signal from a flight controller) to determine if the electric aircraft is in a state of flight or in a state of on-ground charging. Such a configuration may reduce reliance on a single signal to indicate the state, providing redundancy.

The control unit may also collect data from the electric aircraft while the aircraft is on-ground but in an active (i.e., non-charging) state, such as taxiing or preparing for take-off, and save this data to the data storage unit for subsequent transmission when the aircraft is in a state of on-ground charging.

The sensor may be an electrically operated switch, such as a relay which is configured to be energised by connection of the charging port to the ground-side charger and thereby issue the trigger signal.

The sensor may be further configured to issue the trigger signal to the control unit continuously while the charging port is connected to the ground-side charger, the control unit being further configured to command the data transmitter to transmit the inflight data only while in receipt of the trigger signal. This configuration can further simplify the logic implemented by the control unit. The data logging and transmission device may simply transfer data while in receipt of the trigger signal and save data while not in receipt of the trigger signal. Thus, the data logging and transmission device is not required to “assume” any state of the aircraft and, as such, this may further lower requirements for certification.

The data transmitter may be a cellular modem for transfer of the saved inflight data to a remote cellular receiver.

At least the control unit, the data storage unit and the data transmitter of the data logging and transmission device are configured as a module that is installable or replaceable as self-contained unit from the aircraft.

In a second aspect, the present disclosure provides an electric aircraft having a charging port for on-ground charging of an energy storage system of an electric propulsion system of the aircraft, and the data logging and transmission device of the previous aspect. The data logging and transmission device may conveniently be part of the electrical propulsion system, which can be packaged as a single module to be outfitted to the electric aircraft.

In a third aspect, the present disclosure provides a combination of the electric aircraft of the previous aspect and a charger connected thereto at the charging port.

In a fourth aspect, the present disclosure provides a method for wirelessly transmitting inflight data collected from an electric aircraft to a remote receiver, the electric aircraft having a charging port for on-ground charging of an energy storage system of an electric propulsion system of the aircraft, the electric aircraft further having a data transmitter, and a data storage unit for saving inflight data collected during flight of the electric aircraft, the method including: connecting the charging port to a ground-side charger to charge the energy storage system; and while the charging port and the ground-side charger are connected, commanding the data transmitter to transmit the inflight data saved on the data storage unit to a remote receiver. Conveniently, the data transmitter may be a cellular modem.

The invention includes the combination of the aspects and preferred features described except where such a combination is clearly impermissible or expressly avoided.

### BRIEF DESCRIPTION OF THE DRAWINGS

Embodiments and experiments illustrating the principles of the invention will now be discussed with reference to the accompanying figures in which:

FIG. 1 is a perspective view of an electric aircraft in a VTOL configuration; and

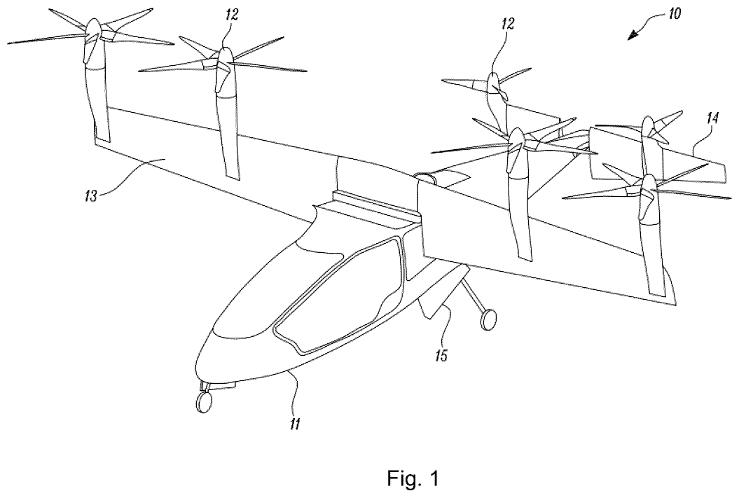

FIG. 2 is a schematic illustration of a ground-side charger and an onboard EPS.

### DETAILED DESCRIPTION

Aspects and embodiments of the present invention will now be discussed with reference to the accompanying figures. Further aspects and embodiments will be apparent to those skilled in the art. All documents mentioned in this text are incorporated herein by reference.

As noted above, it would be desirable to perform regular health assessments to identify faults and possible maintenance needs of such aircraft systems. To this end, an electric aircraft may include a Data Logging and Transmission Unit (DLTU). The DLTU logs inflight data relevant to the health of the aircraft and transfers this data to a remote server for analysis. It is convenient that this data is transferred via cellular data, which is a high powered radio transmission. Due to the potential risk of this transmission interfering with the onboard electronics of the aircraft, the DLTU logs data while the aircraft is in flight, but may only transmit this data to a remote receiver while the aircraft is grounded.

To enable the DLTU to switch between these logging and transmission modes, a signal may be required from which the DLTU to determine the flight status of the aircraft. Conventional aircraft may use a Weight on Wheels (WoW) sensor to detect the grounded state of the aircraft and generate a corresponding WOW signal. However, WoW signals have drawbacks with respect to electric aircraft applications. For example, it is increasingly the case that electric aircraft, in particular small electric aircraft, do not have WoW signal capability. A WoW-reliant DLTU package would thus not be able to operate across the full range of new electric aircraft. Moreover, there is an issue that WoW sensors do not provide information as to whether an aircraft is about to take off. Therefore, data transmission reliant on WOW signals may be abruptly terminated on take-off, which may lead to loss or corruption of inflight data.

Additionally, the WoW signal is a continuous signal which fluctuates during landing. WoW-reliant DLTU must read this fluctuating signal and continuously make a decision as to whether or not the aircraft is grounded. To further complicate this decision-making process, there may be a requirement for the DLTU to save the inflight data to a data storage unit (but not to transmit them) in circumstances in which the aircraft is grounded but still operational (e.g. while taxiing or preparing for take-off). These two factors increase the complexity of the 30 DLTU logic. An incorrect decision by the DLTU may be detrimental to the integrity of the aircraft components and as such, this complexity results in increased certification requirements. These high certification requirements result in the DLTU having a high production and maintenance cost.

The present invention provides a data logging and transmission device for an electric aircraft that may address one or more of the above drawbacks.

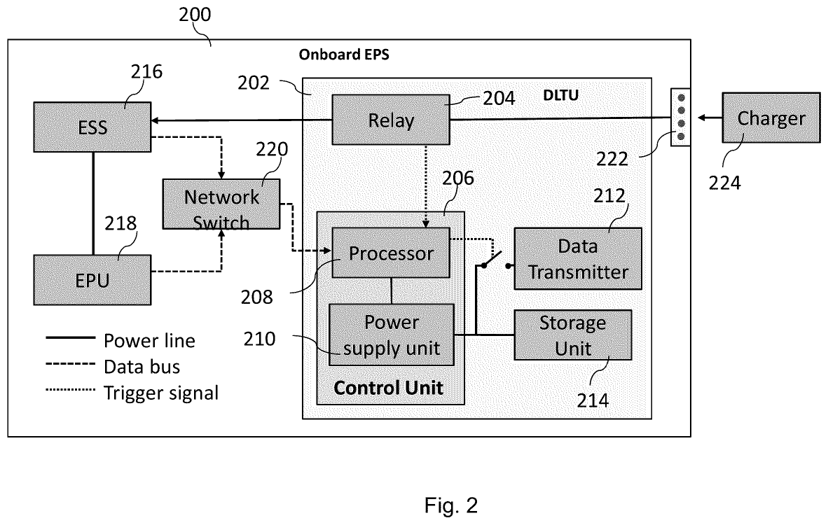

FIG. 2 illustrates an onboard Electrical Propulsion System (EPS) 200 for an electric aircraft and a ground-side charger 224. The EPS 200 comprises an energy storage system (ESS) 216, an Electric Propulsion Unit (EPU) 218, a network switch 220, a data logging and transmission device in the form of a DLTU 202, and a charging port 222. The charger 224 may connect to the charging port 222 of the electric aircraft to transfer electrical energy to the ESS 216. The ESS 216 may comprise one or many batteries, and stores electrical energy that is distributed to the EPU 218 and other aircraft systems (not shown in FIG. 2) during operation. The EPU 218 may comprise multiple electric propulsion assemblies. Each electric propulsion assembly may comprise one or many electric motors, and a respective DC:AC converter for each electric motor. While the electric propulsion assembly is in use, the DC:AC converter converts DC power from the ESS 216 to AC power for its electric motor. The electric motors are used to propel the electric aircraft and may, for example, be front or rear propulsors. They may tilt while the aircraft is in flight. Both the ESS 216 and the EPU 218 send sensor and other inflight data to the network switch 220. The network switch 220 forwards this data to the DLTU 202.

The DLTU 202 comprises a data transmitter 212, a data storage unit 214, a relay 204, and a control unit 206 further comprising a processor 208 and a power supply unit 210. The DLTU 202 components are powered by the power supply unit 210. The relay 204 sits on an input power line connecting the charging port 222 and the ESS 216. On connection of the charger 224 to the charging port 222, current runs from the charging port 222, through the relay 204, to the ESS 216. This current energises the relay 204 to send a trigger signal to the control unit 206.

Preferably, the DLTU 202 is a self-contained module that is installable or replaceable as self-contained unit from the aircraft. In this case, one option (shown in FIG. 2) is for such a module to provide all of the data transmitter 212, data storage unit 214, relay 204, control unit 206. However, another option (not shown) is for DLTU 202 to contain only some of the components of the data logging and transmission device. In particular, the relay 204 can be located outside the module, and in this case it can be installed or replaced separately from the DLTU 202.

The control unit 206 then has two inputs: data from the network switch 220 which continuously transfers inflight data while the aircraft is in flight, and a trigger signal from the relay 204 which indicates the charging state of the aircraft. When the trigger signal indicates that the aircraft is not in a state of on-ground charging, the control unit 206 can save inflight data received from the network switch 220 to the data storage unit 214. Conversely, when the trigger signal indicates that the aircraft is in a state of on-ground charging, the control unit 206 switches on the data transmitter 212 and transmits the inflight data saved on the data storage unit 214 to a remote receiver. This remote receiver forwards the transmitted inflight data to a server for system analysis. The data transmitter 212 may conveniently be a cellular data transmitter for transmission to a cellular receiver.

Advantageously, the DLTU 202 transmits data only while the aircraft is both grounded and effectively dormant (because connected to the ground-side charger 224). While in flight, or in non-dormant (i.e., active) grounded states (e.g., taxiing or preparing for take-off) the DLTU 202 can instead save data to the data storage unit 214. As a result of this, the DLTU 202 has a very low risk of transmitting inflight data while aircraft systems that may be adversely affected by such transmission are operational. Thus, the DLTU 202 has low certification requirements and therefore a low associated cost.

Another advantage of the DLTU 202 is that it may be outfitted to electric aircraft (e.g., small electric aircraft) which do not provide a WoW signal or only provide an unreliable WOW signal. Rather, the DLTU's 202 trigger signal is produced internally on connection of the aircraft's charging port to a ground-side charger, and is independent of the airframe to which the DLTU is fitted.

Moreover, the DLTU 202 can have a low logical complexity. The logging/transmission state of the DLTU 202 may be dependent only on the signal produced by the relay 204. This trigger signal may have discrete pulses sent at the initiation and termination of charging to identify the beginning and end of charging, or, conveniently, it may be continuously in one state (e.g., “on”) for the duration of charging, and continuously in another state (e.g., “off”) at other times.

Furthermore, the DLTU 202 is not dependent on any WoW sensor of the aircraft, instead requiring only the reception of the trigger signal from the relay 204 to initiate data transfer. The control unit 206 is therefore not required to make a complex logging/transmission decision based on, for example, a continuous WOW signal. The DLTU's 202 lack of dependence on a WoW sensor also allows for the unit to be outfitted to a wider range of electric aircraft.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A data logging and transmission device for an electric aircraft having a charging port for on-ground charging of an energy storage system of an electric propulsion system of the aircraft, the device comprising: a control unit, a data storage unit, a data transmitter, and a sensor configured to detect connection of the charging port of the electric aircraft to a ground-side charger and then issue a trigger signal to the control unit, wherein the control unit is configured such that:
in a state of flight of the electric aircraft, the control unit collects inflight data from the electric aircraft and saves the inflight data to the data storage unit, and
in a state of on-ground charging of the electric aircraft, the control unit, on receipt of the trigger signal, commands the data transmitter to transmit the inflight data saved on the data storage unit to a remote receiver.

2. The data logging and transmission device of claim 1, wherein the sensor is a relay.

3. The data logging and transmission device of claim 1, wherein the sensor is further configured to issue the trigger signal to the control unit continuously while the charging port is connected to the ground-side charger, the control unit being further configured to command the data transmitter to transmit the inflight data only while in receipt of the trigger signal.

4. The data logging and transmission device of claim 1, wherein the data transmitter is a cellular modem.

5. The data logging and transmission device of claim 1, wherein at least the control unit, the data storage unit and the data transmitter of the data logging and transmission device are configured as a module that is installable or replaceable as self-contained unit from the aircraft.

6. An electric aircraft having a charging port for on-ground charging of an energy storage system of an electric propulsion system of the aircraft, and the data logging and transmission device of claim 1.

7. A combination of the electric aircraft of claim 6 and a ground-side charger connected thereto at the charging port of the electric aircraft.

8. A method for wirelessly transmitting inflight data collected from an electric aircraft to a remote receiver, the electric aircraft having a charging port for on-ground charging of an energy storage system of an electric propulsion system of the aircraft, and the electric aircraft further having a data transmitter, and a data storage unit for saving inflight data collected during flight of the electric aircraft, the method including:
connecting the charging port to a ground-side charger to charge the energy storage system; and
while the charging port and the ground-side charger are connected, commanding the data transmitter to transmit the inflight data saved on the data storage unit to a remote receiver.

9. The method of claim 8, wherein the data transmitter is a cellular modem.
